(19) United States
(12) Patent Application Publication
(10) Pub. No.: US 2026/0135052 A1
(43) Pub. Date: May 14, 2026

(54) SYSTEM AND METHOD FOR REGULATING A VOLTAGE SIGNAL

(71) Applicant: RESIDEO LLC, Golden Valley, MN (US)

(72) Inventors: Ever Adrian Hernandez, Chihuahua (MX); Rafael Aguilar, Atizapan de Zaragoza (MX); Rafael Ignacio Gonzalez, Chihuahua (MX)

(73) Assignee: RESIDEO LLC, Golden Valley, MN (US)

(21) Appl. No.: 19/124,402

(22) PCT Filed: Sep. 29, 2023
(86) PCT No.: PCT/US2023/075590

§ 371 Date: Apr. 25, 2025

Related U.S. Application Data
(60) Provisional application No. 63/380,824, filed on Oct. 25, 2022.

(51) Int. Cl. H01H 47/00; H01H 47/22

(52) U.S. Cl. CPC H01H 47/002; H01H 47/001; H01H 47/22; H01H 2047/006

(57) ABSTRACT

A relay driver control system comprising: a microcontroller in electrical communication with a relay driver; a call signal conditioner unit in electrical communication with the microcontroller, the call signal conditioner unit configured to receive a call signal and provide a conditioned call signal to the microcontroller; a voltage signal conditioner unit in electrical communication with the microcontroller, the voltage signal conditioner unit configured to receive a voltage signal and provide a conditioned voltage signal to the microcontroller; wherein the microcontroller is configured to: monitor the conditioned call signal relative to a cycle time range; monitor the conditioned voltage signal relative to a voltage signal range; and output an activation signal to activate the relay driver when the conditioned voltage signal is within the voltage signal range and the conditioned call signal is within the cycle time range.

### CROSS REFERENCE TO RELATED APPLICATIONS

This application claims the benefit of, and priority to, U.S. Provisional Patent Application No. 63/380,824 filed Oct. 25, 2022, its entirety of which is incorporated herein by reference.

### FIELD

The present disclosure relates to a system and method for regulating a voltage signal, and more particularly to a system and method for regulating a voltage signal to a relay driver.

### BACKGROUND

Relays are electrically controlled devices configured to control the operation of one or more other devices by opening or closing electrical contacts of the relay. Ideally, the operating lifetime of a relay should last as long as the manufacturer of the relay indicates. However, the relay lifetime may be compromised by, for example, damage to one or more components of the relay.

Relay component damage may be caused by a switching frequency of the relay being above a preferred switching frequency. This high switching frequency may itself be caused by, for example, a control signal of the relay having a high switching frequency. Furthermore, in electromagnetic relays comprising coils, a coil voltage that is below a required operating voltage may also cause a high switching frequency.

Relay chattering (or contact chattering) may also cause component damage. Chattering may occur when, for example, a pair of contacts of the relay close and a mechanical impact causes the contacts to rebound and ‘bounce’. Chattering may also occur as a result of external forces, such as a control voltage applied to the coil. If the control voltage drops below an operational voltage, the relay may chatter. An additional external force may be a consequence of using a control switch. The control switch may intermittently cycle on and off rapidly, which may lead to the contacts chattering.

One solution to the relay component damage problem may comprise the use of a low voltage monitoring device and an input signal delaying device embedded in a microcontroller. However, such a configuration may require significant cost and development time.

Another solution may comprise adding a snubber circuit to the load connected to the relay in order to minimize energy dissipated between the relay contacts when they are switched. A disadvantage of this solution is that despite minimizing the probability of damage by electrical switching, mechanical switching is not minimized, and damage may still occur.

Another solution may comprise the use of a low voltage monitoring device and an input signal delay means using a discrete circuit having a filter to eliminate high frequency components of the control signal, and a voltage regulator to monitor and/or prevent a low voltage. Whilst being a low-cost solution, this is not as flexible as other solutions in that it may be difficult to add additional features to the device.

The present disclosure has been devised to mitigate at least some of the above-mentioned problems.

### SUMMARY

In accordance with a first aspect of the present disclosure, there is provided a relay driver control system comprising: a microcontroller in electrical communication with a relay driver; a call signal conditioner unit in electrical communication with the microcontroller, the call signal conditioner unit configured to receive a call signal and provide a conditioned call signal to the microcontroller; a voltage signal conditioner unit in electrical communication with the microcontroller, the voltage signal conditioner unit configured to receive a voltage signal and provide a conditioned voltage signal to the microcontroller; wherein the microcontroller is configured to: monitor the conditioned call signal relative to a cycle time range; monitor the conditioned voltage signal relative to a voltage signal range; and output an activation signal to activate the relay driver when the conditioned voltage signal is within the voltage signal range and the conditioned call signal is within the cycle time range.

The “relay driver” may be understood as a device suitable for receiving a control signal, and for controlling a relay. The relay may be any suitable relay, such as a mechanical or solid-state relay.

The “call signal” may be understood as a signal intended to activate the relay. The call signal may be received from, for example, a secondary of a transformer of a sensor device or a call signal source such as a humidistat configured to activate a de-humidifier. The transformer may be a 120 VAC/24 VAC transformer.

The “voltage signal” may be understood as a constant AC voltage waveform for powering the microcontroller. The voltage signal may be received from the transformer. The voltage signal may be distinguished from the call signal in that, whilst the call signal and the voltage signal are both received from the transformer, the call signal may not be a constant signal, and may only activated when a “call” is required. By contrast, the voltage signal may be a constant AC voltage signal received directly from the output of the transformer.

The “voltage signal range” may be a predetermined range of voltages associated with the voltage signal received by the microcontroller. The range of voltages may be bounded by an upper threshold and a lower threshold.

The “cycle time range” may be a predetermined range of cycle times associated with the conditioned call signal received by the microcontroller. The “cycle time” may be a duration between subsequent transitions from a low level voltage of the conditioned call signal to a high level voltage of the conditioned call signal. The range of cycle times may be bounded by an upper cycle time and a lower cycle time.

The “activation signal” may be a signal provided to the relay driver by the microcontroller, which causes the relay driver to activate and control the relay. The microcontroller may also provide a deactivation signal to deactivate the relay driver when the conditioned voltage signal is outside of the voltage signal range and/or the conditioned call signal is outside of the cycle time range.

The present system may advantageously provide a means for controlling the activation of the relay driver to minimise a chattering in the relay. In particular, the system may provide an activation signal to the relay driver when both the conditioned voltage signal is within the voltage signal range and the conditioned call signal is inside the cycle time range.

The voltage signal range and the cycle time range may be predetermined so as to minimise the chattering in the relay. In particular, the cycle time range may be predetermined so as to minimise chattering in the relay driver caused by higher frequency call signals and lower frequency call signals. The voltage signal range may be predetermined so as to minimise chattering in the relay driver caused by higher voltages and lower voltages.

In some embodiments, the cycle time range is defined by a lower cycle time threshold and an upper cycle time threshold. In some embodiments, the lower cycle time threshold is predetermined and the upper cycle time threshold is predetermined. In some embodiments, a machine learning algorithm may optimise the lower cycle time threshold and the upper cycle time threshold. In this way, the microcontroller may limit output of the activation signal to situations wherein the cycle time is not below the lower cycle time threshold and not above the upper cycle time threshold. Advantageously, the system may minimise chattering in the relay driver caused by higher frequency call signals and lower frequency call signals.

In some embodiments, the voltage signal range is defined by a lower voltage threshold and an upper voltage threshold. In some embodiments, the lower voltage threshold is predetermined and the upper voltage threshold is predetermined. In some embodiments, a machine learning algorithm may be optimise the lower voltage threshold and the upper voltage threshold. In this way, the microcontroller may limit output of the activation signal to situations wherein the input voltage level is not below the lower voltage threshold and not above the upper voltage threshold. Advantageously, the system may avoid chattering in the relay driver caused by higher voltages and lower voltages.

The call signal conditioner unit is preferably configured to condition the call signal to generate the conditioned call signal. The term “condition the call signal” may be understood as modifying or adapting the call signal received by the call signal conditioner unit such that it is in a form suitable for receipt at the microcontroller. Conditioning the call signal may advantageously convert the call signal to an input signal suitable for the microcontroller interrupt input.

In some embodiments, the call signal conditioner unit comprises: a call signal rectifier configured to convert an AC call signal to a pulsating DC call signal; a call signal voltage dividing unit configured to reduce a voltage of the pulsating DC call signal; and a call signal voltage filter configured to convert the pulsating DC call signal to a substantially constant DC voltage signal. In this way, the call signal conditioner unit may convert the AC call signal into a substantially constant DC call signal for providing to the microcontroller.

In some embodiments, the call signal rectifier comprises a diode. In this way, the call signal rectifier may allow only one half-cycle of the input AC call signal through, such that a pulsating DC call signal is generated. Advantageously, the call signal rectifier may convert the AC call signal to a DC call signal using minimal components.

In some embodiments, the call signal voltage dividing unit comprises a first resistor connected with a second resistor. Preferably, the first resistor is arranged in series with the call signal rectifier. In this way, a voltage of the DC call signal may be reduced by the call signal voltage dividing unit. Reducing the voltage of the DC call signal may advantageously provide the call signal in a suitable form for the microcontroller interrupt input. Utilising a resistor configuration in this manner may advantageously provide a simple way for reducing the voltage of the DC call signal.

In some embodiments, the call signal voltage filter comprises a capacitor. In this way, the capacitor may discharge when the diode becomes reverse biased, such that the pulsating DC call signal is converted to a substantially constant, or stable, DC call signal. Advantageously, having a constant call signal may avoid relay chattering.

Preferably, the voltage signal conditioner unit is configured to condition the voltage signal to generate the conditioned voltage signal. The term “condition the voltage signal” may be understood as modifying or adapting the voltage signal received by the voltage signal conditioner unit such that it is in a form suitable for receipt at the microcontroller. Conditioning the voltage signal in this way may advantageously convert the voltage signal to a signal suitable for receipt by the microcontroller.

In some embodiments, the voltage signal conditioner unit comprises: a voltage signal rectifier configured to convert an AC voltage signal to a pulsating DC voltage signal; a voltage signal voltage dividing unit configured to reduce a voltage of the pulsating DC voltage signal; and a voltage signal voltage filter configured to convert the pulsating DC voltage signal to a substantially constant DC voltage signal. In this way, the voltage signal conditioner unit may convert the AC voltage signal into a substantially constant DC voltage signal for providing to the microcontroller.

In some embodiments, the voltage signal rectifier comprises a diode. In this way, the voltage signal rectifier may allow only one half-cycle of the input AC voltage signal through, such that a pulsating DC voltage signal is generated. Advantageously, the voltage signal rectifier may convert the AC voltage signal to a DC voltage signal using minimal components.

In some embodiments, the voltage signal voltage dividing unit comprises a first resistor connected with a second resistor. Preferably, the first resistor is arranged in series with the voltage signal rectifier. In this way, a voltage of the DC voltage signal may be reduced by the voltage signal voltage dividing unit.

In some embodiments, the voltage signal voltage filter comprises a capacitor. In this way, the capacitor may discharge when the diode becomes reverse biased, such that the pulsating DC voltage signal is converted to a substantially constant, or stable, DC voltage signal.

In some embodiments, the relay driver control system further comprises a power supply in electrical communication with the microcontroller, the power supply being configured to receive an input voltage and provide an input power to the microcontroller. In this way, the power supply may provide a means for powering the microcontroller.

In some embodiments, the relay driver control system further comprises an input voltage rectifier in electrical communication with the power supply, the input voltage rectifier configured to convert an AC input voltage to a pulsating DC input voltage. The input voltage rectifier may be a diode. In this way, the input voltage rectifier may convert the AC input voltage to a DC input voltage using minimal components.

In some embodiments, the relay driver control system further comprises an input voltage filter in electrical communication with the input voltage rectifier and the power supply, the input voltage filter configured to convert the pulsating DC input voltage to a substantially constant DC input voltage for the power supply. In this way, the capacitor may discharge when the diode becomes reverse biased, such that the pulsating DC input voltage is converted to a substantially constant, or stable, DC input voltage. Advantageously, the power supply may receive a substantially constant DC input voltage.

In some embodiments, the power supply is adapted to reduce the constant DC input voltage to a suitable microcontroller voltage for providing to the microcontroller. In some embodiments, the suitable microcontroller voltage is 3.3 V. In alternative embodiments, the suitable microcontroller voltage is 5 V. It will be appreciated that any suitable microcontroller voltage may be implemented. Advantageously, the power supply may adequately power the microcontroller.

In accordance with a third aspect of the present disclosure, there is provided a relay driver control method comprising the steps of: receiving, at a microcontroller from a call signal conditioner unit, a conditioned call signal; receiving, at the microcontroller from a voltage signal conditioner unit, a conditioned voltage signal; monitoring, by the microcontroller, the conditioned call signal relative to a cycle time range; monitoring, by the microcontroller, the conditioned voltage signal relative to a voltage signal range; and outputting, by the microcontroller, an activation signal to activate the relay driver when the conditioned voltage signal is within the voltage signal range and the conditioned call signal is within the cycle time range.

In some embodiments, the method further comprises: converting, by a call signal rectifier, an AC call signal to a pulsating DC call signal; reducing, by a call signal voltage dividing unit, a voltage of the pulsating DC call signal; and converting, by a call signal voltage filter, the pulsating DC call signal to a substantially constant DC call signal.

In some embodiments, the method further comprises: converting, by a voltage signal rectifier, an AC voltage signal to a pulsating DC voltage signal; reducing, by a voltage signal voltage dividing unit, a voltage of the pulsating DC voltage signal; and converting, by a voltage signal voltage filter, the pulsating DC voltage signal to a substantially constant DC voltage signal.

In some embodiments, the method further comprises: receiving, at a power supply, an input voltage; and receiving, at the microcontroller, an input power from the power supply.

In some embodiments, the method further comprises: converting, by an input voltage rectifier, an AC input voltage to a pulsating DC input voltage.

In some embodiments, the method further comprises: converting, by an input voltage filter, the pulsating DC input voltage to a substantially constant DC input voltage for the power supply.

In accordance with a third aspect of the present disclosure, there is provided a relay comprising: a relay driver; and a relay driver control system.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

Embodiments will now be described by way of example only with reference to the following Figures in which:

FIG. 1A shows a systematic view of a relay driver control system in accordance with a first aspect of the present disclosure;

FIG. 1B depicts a voltage-time graph;

FIG. 1C depicts a voltage-time graph;

FIG. 1D depicts a voltage-time graph;

FIG. 2 shows a flow diagram of a relay driver control method in accordance with a second aspect of the present disclosure; and

FIG. 3 shows a flow diagram of an alternative relay driver control method in accordance with a second aspect of the present disclosure.

### DETAILED DESCRIPTION

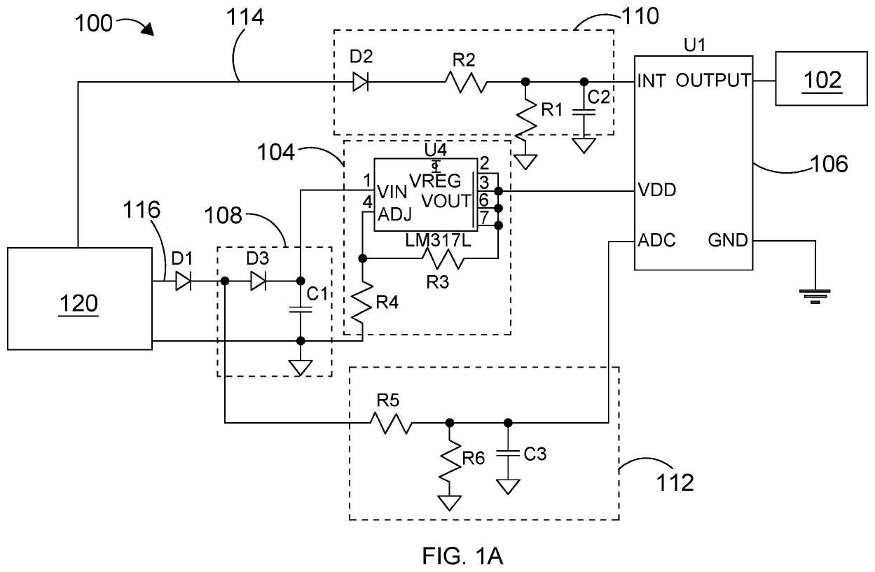

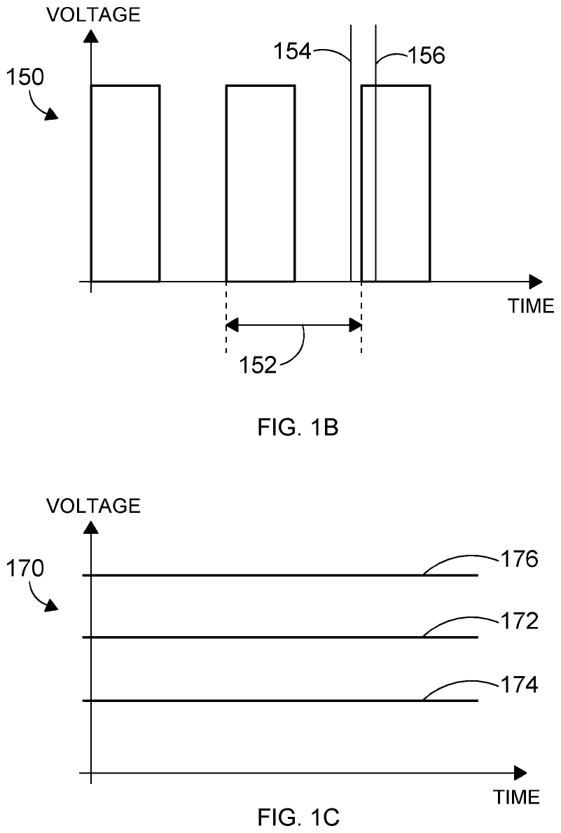

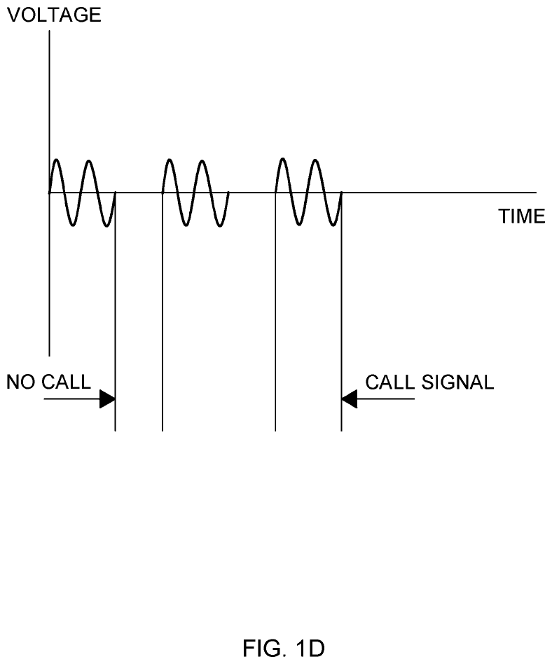

FIG. 1A shows schematic view of a relay driver control system 100 for controlling a relay driver 102.

The relay driver control system 100 comprises a microcontroller 106 in electrical communication with: a power supply 104; a call signal conditioner unit 110; a voltage signal conditioner unit 112; and the relay driver 102. The relay driver control system 100 further comprises a voltage conversion unit 108 in electrical communication with the power supply 104.

The relay driver 102 is configured to activate a coil (not shown), in response to an activation signal. In this embodiment, the relay driver 102 interacts with the coil through an opto-triac and a triac so as to control current through the coil. The opto-triac is configured to provide electrical isolation with the rest of the system 100. When the relay driver 102 receives the activation signal, an LED of the opto-triac activates, which subsequently triggers the internal triac. The internal triac in turn activates an external triac, the external triac being arranged to allow current to pass through the relay coil to activate it.

The power supply 104 is arranged to receive a power supply voltage signal from the voltage conversion unit 108. The voltage conversion unit 108 is configured to receive an input AC voltage signal, for example from a secondary of a 120V/24V transformer of an input device 120, and convert the input AC voltage signal to a substantially constant DC voltage signal. In the present example, the voltage conversion unit 108 comprises an input voltage rectifier in electrical communication with an input voltage filter. The input voltage rectifier comprises a diode D3, and is configured to allow only one half-cycle of the input AC voltage signal through, such that a pulsating DC voltage is generated. The input voltage filter comprises a capacitor C1. The input voltage filter is configured to discharge when the diode becomes reverse biased, such that the pulsating DC voltage is converted to a substantially constant DC voltage. The substantially constant DC voltage is provided to the power supply 104. It will be appreciated that further rectifier topologies may be utilised, however the present topology is advantageously simple.

The power supply 104 is also arranged to provide an input power to the microcontroller 106. In the present example, the power supply 104 is arranged to provide a 5 V microcontroller voltage to the microcontroller 106. In alternative embodiments, the power supply 108 is arranged to provide a 3.3 V microcontroller voltage to the microcontroller 106. It will be appreciated that the power supply 104 may be arranged to provide any suitable microcontroller voltage to the microcontroller 106. The power supply 108 is arranged to provide the microcontroller voltage based on a linear adjustable voltage regulator U4, and a voltage divider comprising a first resistor R3 and a second resistor R4. The voltage divider is an adjustable circuit component, and is configured to adjust output voltage of the linear adjustable voltage regulator U4.

The call signal conditioner unit 110 is in electrical communication with the microcontroller 106 and a call signal input 114. The call signal conditioner unit 110 is configured to receive or detect a call signal from the call signal input 114 (the call signal input 114 being received from the input device 120), and to condition the call signal to generated a conditioned call signal, such that it is suitable for receipt by the microcontroller 106. FIG. 1D depicts a voltage-time graph comprising a plurality of call signal periods and a plurality of no call signal periods. The conditioned call signal is a voltage signal to trigger the relay by applying a suitable voltage to the coil, and is received from, for example a sensor device (not shown) or other source, such as a humidistat or any other suitable device for controlling a plant like a de-humidifier. The call signal conditioner unit 110 comprises a call signal rectifier in electrical communication with a call signal voltage dividing unit, and a call signal voltage filter. The call signal rectifier comprises a diode D2, and is configured to allow only one half-cycle of the call signal through, such that a pulsating DC voltage signal is generated. The call signal voltage dividing unit comprises a first resistor R1 connected with a second resistor R2 in series with the diode D2, and is configured to reduce a voltage of the pulsating DC call signal such that it is suitable for the interrupt input of the microcontroller. The call signal voltage filter comprises a capacitor C2. The capacitor C2 is configured to discharge when the diode D2 becomes reverse biased, such that the pulsating DC call signal is converted to a substantially constant, or stable, DC call signal having a ripple voltage waveform. The stable DC call signal may advantageously avoid relay chattering.

The microcontroller 106 is configured to receive the constant DC voltage signal (i.e. the conditioned call signal) from the call signal conditioner unit 110. The microcontroller 106 is configured to determine a cycle time of the conditioned call signal based on a frequency of the voltage waveform, such as the frequency of the voltage waveform depicted in FIG. 1D. In particular, the microcontroller 106 is configured to determine a duration between subsequent transitions from a low-level voltage of the ripple voltage waveform to a high level voltage of the ripple voltage waveform, wherein the duration is the cycle time. The microcontroller 106 is also configured to determine whether the cycle time falls within a cycle time range. The cycle time range is defined by a lower cycle time threshold and an upper cycle time threshold, such the cycle time falls within the cycle time range when the cycle time is above the lower cycle time threshold, and below the upper cycle time threshold. FIG. 1B depicts a voltage-time graph 150, wherein a cycle time 152 falls within a cycle time range defined by a lower cycle time threshold 154 and an upper cycle time threshold 156.

The voltage signal conditioner unit 112 in electrical communication with the microcontroller 106 and a voltage signal input 116. In the present example, the voltage signal input 116 is from the input device 120. However, the call signal is a switched signal whilst the voltage signal is a constant signal. The voltage signal conditioner unit 112 is configured to receive or detect an input voltage signal from the voltage signal input 116, and to condition the input voltage signal to generate a conditioned voltage signal for receipt at the microcontroller 106. The voltage signal conditioner unit 112 comprises a voltage signal rectifier in electrical communication with a voltage signal voltage dividing unit and a voltage signal voltage filter. The voltage signal rectifier comprises a diode D1 and is configured to allow only one half-cycle of the voltage signal through, such that a pulsating DC voltage signal is generated. The voltage signal voltage dividing unit comprises a first resistor R5 connected with the diode D1, and a second resistor R6 connected with the resistor R5. The voltage signal voltage dividing unit is configured to reduce a voltage of the voltage signal. The voltage signal voltage filter comprises a capacitor C3 in parallel with the resistor R6. The capacitor C3 is configured to discharge when the diode D1 becomes reverse biased, such that the pulsating DC voltage signal is converted to a substantially constant, or stable, DC voltage signal (i.e. the conditioned voltage signal).

The microcontroller 106 is configured to receive the constant DC voltage signal (i.e. the conditioned voltage signal) from the voltage signal conditioner unit 112. The microcontroller 106 is configured to determine a voltage of the constant DC voltage signal. The microcontroller 106 is also configured to determine whether the voltage falls within a voltage threshold range. The voltage threshold range is defined by a lower voltage threshold and an upper voltage threshold, such that the voltage falls within the voltage threshold range when the voltage is above the lower voltage threshold, and below the upper voltage threshold. FIG. 1C depicts a voltage-time graph 170, wherein a voltage 172 falls within a voltage threshold range defined by a lower voltage threshold 174 and an upper voltage threshold 176.

The microcontroller 106 is in further electrical communication with the relay driver 102. In response to determining that both the cycle time 152 falls within the cycle time range, and the voltage 172 falls within the activation voltage amplitude range, the microcontroller 106 is configured to output an activation signal to the relay driver 102, such that the relay driver activates the relay.

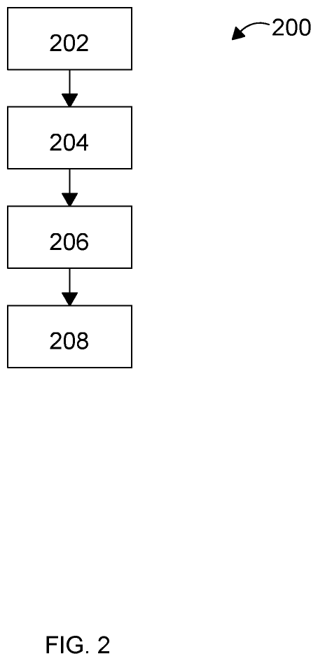

FIG. 2 shows a flow diagram of a method 200 for controlling the relay driver 102 using the relay driver control system 100.

Step 202 of the method 200 comprises receiving, at the microcontroller 106 from the call signal conditioner unit 110, the conditioned call signal.

Step 204 of the method 200 comprises receiving, at the microcontroller 106, from the voltage signal conditioner unit 112, the conditioned voltage signal.

Step 206 of the method 200 comprises monitoring, by the microcontroller 106, the conditioned call signal relative to a cycle time range; and monitoring, by the microcontroller 106, the conditioned voltage signal relative to a voltage signal range.

Step 208 of the method 200 comprises outputting, by the microcontroller 106, an activation signal to activate the relay driver 102 when the voltage 172 of the conditioned voltage signal is within the voltage signal range and the cycle time 152 of the conditioned call signal is within the cycle time range.

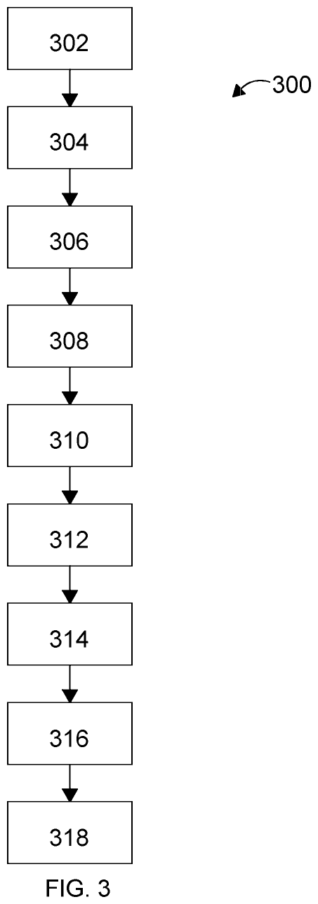

FIG. 3 shows a flow diagram of an alternative method 300 for controlling the relay driver 102 using the relay driver control system 100.

Step 302 of the method 200 comprises converting, by the voltage conversion unit 108, an input AC voltage to a substantially constant DC input voltage. In particular, step 302 comprises converting, by the input voltage rectifier (e.g. the diode D3), the input AC voltage to a pulsating DC input voltage; and converting, by the input voltage filter (e.g. the capacitor C1), the pulsating DC input voltage to the substantially constant DC input voltage.

Step 304 comprises receiving, at the power supply 104, the substantially constant DC input voltage.

Step 306 comprises receiving, at the microcontroller 106, an input power from the power supply.

Step 308 comprises receiving and conditioning, at the call signal conditioner unit 110, a call signal from the call signal input 114, to generate a conditioned call signal. In particular, step 308 comprises converting, by the call signal rectifier (e.g. the diode D2), an AC call signal to a pulsating DC call signal; reducing, by the call signal voltage dividing unit (e.g. the first resistor R1 and the second resistor R2), a voltage of the pulsating DC call signal; and converting, by the call signal voltage filter (e.g. the capacitor C2), the pulsating DC call signal to a substantially constant DC call signal (i.e. the conditioned call signal).

Step 310 comprises receiving, at the microcontroller 106, the substantially constant DC call signal (i.e. the conditioned call signal).

Step 312 comprises receiving and conditioning, at the voltage signal conditioner unit 112, a voltage signal from the voltage signal input 116, to generate a conditioned voltage signal. In particular, step 312 comprises converting, by the voltage signal rectifier (e.g. the diode D1), an AC voltage signal to a pulsating DC voltage signal; reducing, by the voltage signal voltage dividing unit (e.g. the first resistor R5 and the second resistor R6), a voltage of the pulsating DC voltage signal; and converting, by the voltage signal voltage filter (e.g. the capacitor C3), the pulsating DC voltage signal to a substantially constant DC voltage signal (i.e. the conditioned voltage signal).

Step 314 comprises receiving, at the microcontroller 106, the substantially constant DC voltage signal (i.e. the conditioned voltage signal).

Step 316 comprises monitoring the conditioned call signal relative to the cycle time range. In particular, step 316 comprises determining that the cycle time 152 of the conditioned call signal falls within the cycle time range defined by the lower cycle time threshold 154 and the upper cycle time threshold 156.

Step 316 also comprises monitoring the conditioned voltage signal relative to the voltage signal range. In particular, step 316 comprises determining that the voltage 172 of the conditioned voltage signal falls within the voltage threshold range defined by the lower voltage threshold 174 and the upper voltage threshold 176.

Step 318 comprises outputting, by the microcontroller 106, an activation signal to activate the relay driver 102 when the voltage 172 of the conditioned voltage signal is within the voltage signal range and the cycle time 152 of the conditioned call signal is within the cycle time range.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers'specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A relay driver control system comprising:
a microcontroller in electrical communication with a relay driver;
a call signal conditioner unit in electrical communication with the microcontroller, the call signal conditioner unit configured to receive a call signal and provide a conditioned call signal to the microcontroller;
a voltage signal conditioner unit in electrical communication with the microcontroller, the voltage signal conditioner unit configured to receive a voltage signal and provide a conditioned voltage signal to the microcontroller;
wherein the microcontroller is configured to:
monitor the conditioned call signal relative to a cycle time range;
monitor the conditioned voltage signal relative to a voltage signal range; and
output an activation signal to activate the relay driver when the conditioned voltage signal is within the voltage signal range and the conditioned call signal is within the cycle time range.

2. The relay driver control system according to claim 1, wherein the cycle time range is defined by a lower cycle time threshold and an upper cycle time threshold.

3. The relay driver control system according to claim 1, wherein the voltage signal range is defined by a lower voltage threshold and an upper voltage threshold.

4. The relay driver control system according to claim 1, wherein the call signal conditioner unit comprises:
a call signal rectifier configured to convert an AC call signal to a pulsating DC call signal;
a call signal voltage dividing unit configured to reduce a voltage of the pulsating DC call signal; and
a call signal voltage filter configured to convert the pulsating DC call signal to a substantially constant DC voltage signal.

5. The relay driver control system according to claim 4, wherein the call signal rectifier comprises a diode.

6. The relay driver control system according to claim 4, wherein the call signal voltage dividing unit comprises a first resistor arranged in parallel with a second resistor.

7. The relay driver control system according to claim 4, wherein the call signal voltage filter comprises a capacitor.

8. The relay driver control system according to preceding claim 1, wherein the voltage signal conditioner unit comprises:
a voltage signal rectifier configured to convert an AC voltage signal to a pulsating DC voltage signal;
a voltage signal voltage dividing unit configured to reduce a voltage of the pulsating DC voltage signal; and
a voltage signal voltage filter configured to convert the pulsating DC voltage signal to a substantially constant DC voltage signal.

9. The relay driver control system according to claim 8, wherein the voltage signal rectifier comprises a diode.

10. The relay driver control system according to claim 8, wherein the voltage signal voltage dividing unit comprises a first resistor connected to a second resistor.

11. The relay driver control system according to claim 8, wherein the voltage signal voltage filter comprises a capacitor.

12. The relay driver control system according to claim 1, further comprising a power supply in electrical communication with the microcontroller, the power supply being configured to receive an input voltage and provide an input power to the microcontroller.

13. The relay driver control system according to claim 12, further comprising an input voltage rectifier in electrical communication with the power supply, the input voltage rectifier configured to convert an AC input voltage to a pulsating DC input voltage.

14. The relay driver control system according to claim 13, further comprising an input voltage filter in electrical communication with the input voltage rectifier and the power supply, the input voltage filter configured to convert the pulsating DC input voltage to a substantially constant DC input voltage for the power supply.

15. The relay driver control system according to claim 14, wherein the power supply is adapted to reduce the constant DC input voltage to a suitable microcontroller voltage for providing to the microcontroller.

16. A relay driver control method comprising:
receiving, at a microcontroller from a call signal conditioner unit, a conditioned call signal;
receiving, at the microcontroller from a voltage signal conditioner unit, a conditioned voltage signal;
monitoring, by the microcontroller, the conditioned call signal relative to a cycle time range;
monitoring, by the microcontroller, the conditioned voltage signal relative to a voltage signal range; and
outputting, by the microcontroller, an activation signal to activate the relay driver when the voltage signal is within the conditioned voltage signal range and the conditioned call signal is within the cycle time range.

17. The relay driver control method according to claim 16, further comprising:
converting, by a call signal rectifier, an AC call signal to a pulsating DC call signal;
reducing, by a call signal voltage dividing unit, a voltage of the pulsating DC call signal; and
converting, by a call signal voltage filter, the pulsating DC call signal to a substantially constant DC call signal.

18. The relay driver control method according to claim 16, further comprising:
converting, by a voltage signal rectifier, an AC voltage signal to a pulsating DC voltage signal;
reducing, by a voltage signal voltage dividing unit, a voltage of the pulsating DC voltage signal; and
converting, by a voltage signal voltage filter, the pulsating DC voltage signal to a substantially constant DC voltage signal.

19. The relay driver control method according to claim 16, further comprising:
receiving, at a power supply, an input voltage; and
receiving, at the microcontroller, an input power from the power supply.

20. The relay driver control method according to claim 19, further comprising:
converting, by an input voltage rectifier, an AC input voltage to a pulsating DC input voltage.

21. (canceled)

22. (canceled)
